(19) United States
(12) Patent Application Publication
(10) Pub. No.: US 2025/0015445 A1
(43) Pub. Date: Jan. 9, 2025

(54) CONDUCTIVE MODULE

(71) Applicant: YAZAKI CORPORATION, Tokyo (JP)

(72) Inventors: Tatsuya Oga, Makinohara-shi (JP); Hirokuni Koike, Makinohara-shi (JP); Yoshiki Aoshima, Makinohara-shi (JP); Kimitoshi Makino, Makinohara-shi (JP)

(21) Appl. No.: 18/752,779

(22) Filed: Jun. 24, 2024

(30) Foreign Application Priority Data
Jul. 3, 2023 (JP) 2023-109356

(51) Int. Cl. H01M 50/503; H01M 50/507; H01M 50/519; H01M 50/569

(52) U.S. Cl. CPC H01M 50/503; H01M 50/507; H01M 50/569; H01M 50/519

(57) ABSTRACT

A wiring component includes a circuit conductor for each of bus bars and is formed to be flexible and flat. The wiring component includes a wiring main body that runs parallel in an arrangement direction of a battery cells, a wiring intersection body that is connected to one end of the wiring main body in the arrangement direction so as to intersect the arrangement direction on the same plane and protrudes from one side end of the wiring main body along the arrangement direction, and a wiring branch body that is branched from the one side end of the wiring main body for each of the plurality of bus bars, and a bent region provided at one end of the wiring main body is bent to change an insertion/removal direction of a connector attached to a distal end of the wiring intersection body with respect to a mating connector.

### CROSS-REFERENCE TO RELATED APPLICATION(S)

The present application claims priority to and incorporates by reference the entire contents of Japanese Patent Application No. 2023-109356 filed in Japan on Jul. 3, 2023.

### BACKGROUND OF THE INVENTION

### 1. Field of the Invention

The present invention relates to a conductive module.

### 2. Description of the Related Art

A conductive module is a wiring module that electrically connects a battery module in which a plurality of battery cells are arranged and a battery monitoring unit that monitors a battery state of the battery cells. The conductive module includes a wiring component that includes a circuit conductor for each bus bar connected to one or a pair of battery cells of the battery module, and a connector that electrically connects each circuit conductor to the battery monitoring unit. This conductive module is disclosed in, for example, Japanese Patent Application Laid-open No. 2011-192612 and Japanese Patent Application Laid-open No. 2012-181442.

Meanwhile, in a conductive module, it is necessary to arrange the connector according to a position of a mating connector changed according to an installation location of a battery monitoring unit or the like. For example, in the conductive module of Japanese Patent Application Laid-open No. 2012-181442, a position of a connector can be changed along an insertion/removal direction with respect to a mating connector. However, when the insertion/removal direction between the connector and the mating connector is changed, the conductive module cannot cope with the change.

### SUMMARY OF THE INVENTION

Therefore, an object of the present invention is to provide a conductive module capable of providing a connector at an appropriate position according to the arrangement of a mating connector.

In order to achieve the above mentioned object, a conductive module according to one aspect of the present invention includes a wiring component and a connector that electrically connect a battery module in which a plurality of battery cells are arranged and a battery monitoring unit that monitors a battery state of the battery cell, wherein the wiring component includes a circuit conductor for each bus bar connected to an electrode terminal of one or a pair of the battery cells of the battery module, is formed to be flexible and flat, and includes a wiring main body that runs parallel in an arrangement direction of the plurality of battery cells, a wiring intersection body that is connected to one end of the wiring main body in the arrangement direction so as to intersect the arrangement direction on the same plane and protrudes from one side end of the wiring main body along the arrangement direction, and a wiring branch body that is branched from the one side end of the wiring main body for each of the plurality of bus bars, the circuit conductor includes a circuit main body extended in the arrangement direction by the wiring main body, a circuit intersection body connected to one end of the circuit main body at the one end of the wiring main body, extended in an intersection direction of the wiring intersection body in the middle of a routing path, and electrically connected to the battery monitoring unit via the connector attached to a distal end of the wiring intersection body before being extended, and a circuit branch body led from other end of the circuit main body to the wiring branch body and electrically connected to the bus bar, and the wiring component bends a bent region provided at the one end of the wiring main body to change an insertion/removal direction of the connector with respect to a mating connector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating a conductive module according to an embodiment;

FIG. 2 is an enlarged view illustrating one end of the conductive module of the embodiment;

FIG. 3 is a perspective view for explaining a battery module;

FIG. 4 is an enlarged view illustrating one end of the conductive module of the embodiment after being bent;

FIG. 5 is an enlarged view of one end of the conductive module of the embodiment after being bent as viewed from a back side;

FIG. 6 is a plan view illustrating a conductive module according to a modification;

FIG. 7 is an enlarged view illustrating one end of a conductive module according to a modification; and

FIG. 8 is an enlarged view illustrating one end of a conductive module of a modification after being bent.

### DETAILED DESCRIPTION OF THE PREFERRED EMBODIMENT

Hereinafter, embodiments of a conductive module according to the present invention will be described in detail with reference to the drawings. Note that the present invention is not limited by the embodiments.

### Embodiment

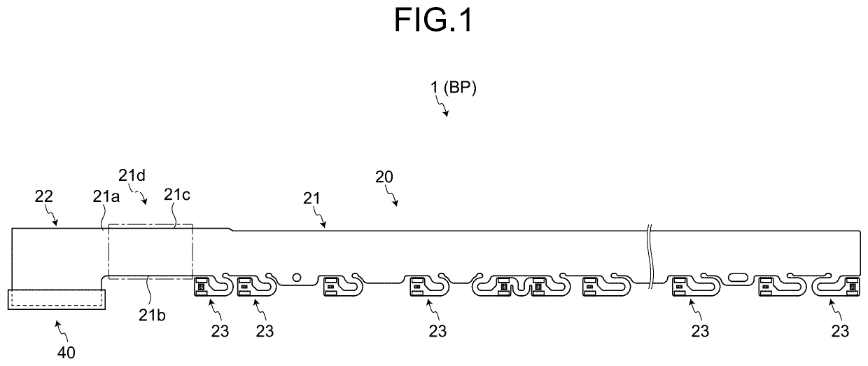

One of embodiments of a conductive module according to the present invention will be described with reference to FIGS. 1 to 5.

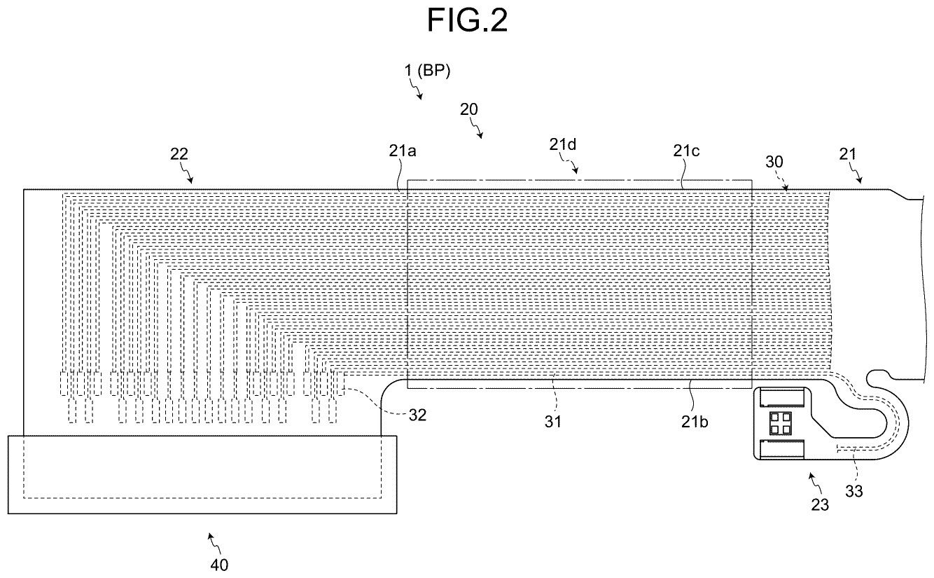

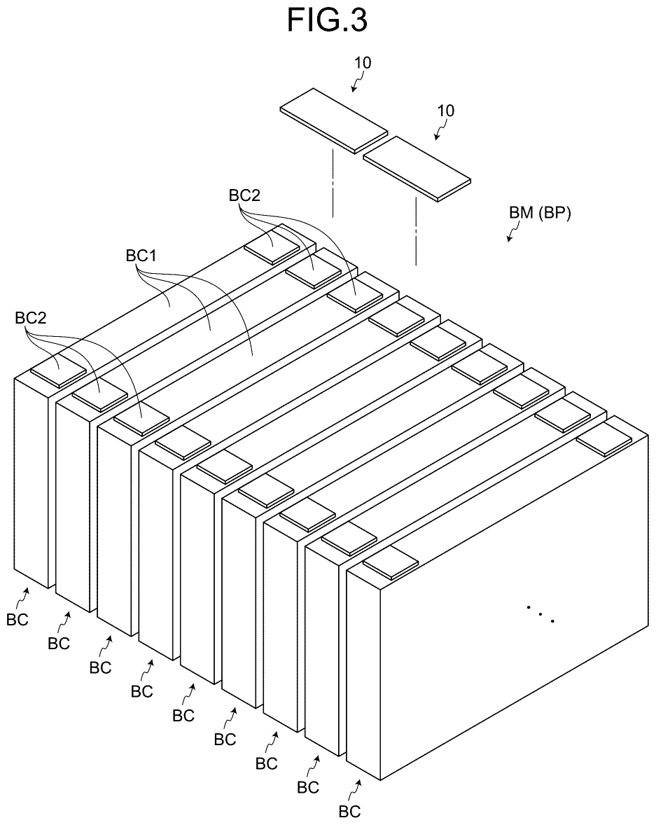

Reference numeral 1 in FIGS. 1 and 2 denotes a conductive module of the present embodiment. The conductive module 1 is assembled to a battery module BM (FIG. 3) in which a plurality of battery cells BC are arranged (e.g., arranged in a single row), and the battery module BM is electrically connected to, for example, a battery monitoring unit (not illustrated), so that the battery monitoring unit monitors the battery state of the battery cell BC. The conductive module 1 constitutes a battery pack BP together with the battery module BM (FIGS. 1 to 3). The battery pack BP is mounted on, for example, a vehicle (BEV: Battery Electric Vehicle, HEV: Hybrid Electric Vehicle, or the like) including a rotary machine as a drive source, and is used for power supply to the rotary machine.

The battery cell BC includes a cell body BC1 and positive and negative electrode terminals BC2 (FIG. 3). In the battery cell BC illustrated here, the cell body BC1 is formed in a rectangular parallelepiped shape having six outer wall surfaces, and the positive and negative electrode terminals BC2 are provided on one of the six outer wall surfaces of the cell body BC1. In the plurality of battery cells BC constituting the battery module BM, the cell bodies BC1 adjacent to each other in the arrangement direction are arranged with one outer wall surface facing each other. Therefore, in the battery cell BC illustrated here, the positive and negative electrode terminals BC2 are provided on one of the four outer wall surfaces along the arrangement direction of the plurality of battery cells BC. On one outer wall surface of the cell body BC1, an electrode terminal BC2 serving as a positive electrode is disposed at one end in a direction orthogonal to the arrangement direction of the plurality of battery cells BC, and an electrode terminal BC2 serving as a negative electrode is disposed at the other end in the orthogonal direction.

Each of the positive and negative electrode terminals BC2 may have, for example, a plate shape or a rectangular parallelepiped shape provided on one outer wall surface of the cell body BC1, and may be a columnar pole protruding from one outer wall surface of the cell body BC1. In the case of the plate-like or rectangular parallelepiped electrode terminal BC2, a bus bar described later is physically and electrically connected to the electrode terminal BC2 by welding or the like. In the case of the electrode terminal BC2 having a pole shape, since a male screw portion is provided in the electrode terminal BC2, the electrode terminal BC2 is inserted into a through hole of the bus bar described later, a female screw member (not illustrated) is screwed into the male screw portion of the electrode terminal BC2, and the bus bar described later is physically and electrically connected to the electrode terminal BC2.

In the battery module BM, the bus bar described later is connected to one or a pair of battery cells BC. In this battery module BM, one electrode terminal BC2 and the other electrode terminal BC2 in the plurality of battery cells BC are arranged in the arrangement direction of the plurality of battery cells BC. In this battery module BM, a pair of one electrode terminals BC2 adjacent to each other in the arrangement direction is electrically connected by a bus bar described later for each of the pair of one electrode terminals BC2. In the battery module BM, the pair of other electrode terminals BC2 adjacent to each other in the arrangement direction is electrically connected by a bus bar described later for each of the pair of other electrode terminals BC2. One of the pair of electrode terminals BC2 adjacent to each other in the arrangement direction may be a positive electrode and the other of the pair of electrode terminals BC2 may be a negative electrode, and both of the pair of electrode terminals BC2 may be a positive electrode or a negative electrode. Here, the plurality of battery cells BC are arranged such that one of the pair of electrode terminals BC2 adjacent in the arrangement direction becomes a positive electrode and the other becomes a negative electrode. In this battery module BM, a bus bar described later is physically and electrically connected to one electrode terminal BC2 serving as the total positive electrode, and a bus bar described later is physically and electrically connected to one electrode terminal BC2 serving as the total negative electrode.

A bus bar 10 illustrated in FIG. 3 is a plate-like conductive component made of metal, and is press-molded using a metal plate as a base material, for example. Here, the plate-like electrode terminal BC2 is taken as an example, and the bus bar 10 is physically and electrically connected to the electrode terminal BC2 by welding or the like. The plurality of bus bars 10 may be included in the battery module BM or may be included in the conductive module 1.

The conductive module 1 includes a wiring component 20 that electrically connects the battery module BM and the battery monitoring unit. The wiring component 20 includes a circuit conductor 30 for each bus bar 10 and is formed to be flexible and flat (FIGS. 1 and 2). Further, the conductive module 1 includes a connector 40 that electrically connects the battery module BM and the battery monitoring unit (FIGS. 1 and 2). The connector 40 is fitted and connected to a mating connector (not illustrated) on the battery monitoring unit side in order to electrically connect the wiring component 20 to the battery monitoring unit.

Specifically, the wiring component 20 illustrated here is a flexible printed circuit board, and the circuit conductor 30 is formed of a conductor pattern such as copper foil. The wiring component 20 includes, as an insulating coating, various films (base film and cover film) formed to be flexible and flat, and a conductor pattern is formed on at least one (base film) of the various films. The conductor pattern (circuit conductor 30) is enclosed by an insulating coating, and for example, a place to be an electrical contact with another component is exposed.

The wiring component 20 includes a wiring main body 21 that runs parallel in the arrangement direction of the plurality of battery cells BC, a wiring intersection body 22 that is connected to one end 21a of the wiring main body 21 in the arrangement direction of the plurality of battery cells BC so as to intersect the arrangement direction on the same plane and protrudes from one side end 21b of the wiring main body 21 along the arrangement direction of the plurality of battery cells BC, and a wiring branch body 23 that is branched from the one side end 21b of the wiring main body 21 for each of the plurality of bus bars 10 (FIGS. 1 and 2). In the following description, the arrangement direction of the plurality of battery cells BC is simply referred to as an arrangement direction.

In the wiring component 20 exemplified here, the plurality of wiring branch bodies 23 are arranged on the same plane as the wiring main body 21 and the wiring intersection body 22.

The circuit conductor 30 includes a circuit main body 31 extended in the arrangement direction by the wiring main body 21, a circuit intersection body 32 connected to one end of the circuit main body 31 at one end 21a of the wiring main body 21, extended in an intersection direction of the wiring intersection body 22 in the middle of a routing path, and electrically connected to the battery monitoring unit via a connector 40 attached to a distal end of the wiring intersection body 22 before being extended, and a circuit branch body 33 led from the other end of the circuit main body 31 to the wiring branch body 23 and electrically connected to the bus bar 10 (FIG. 2).

In the wiring main body 21, between the one side end 21b and the other side end 21c, the circuit main bodies 31 of all the circuit conductors 30 of each bus bar 10 are caused to run in parallel along the arrangement direction at intervals from each other (FIG. 2). In the wiring intersection body 22, the circuit intersection bodies 32 of all the circuit conductors 30 run in parallel along the intersection direction at intervals (FIG. 2). The wiring intersection body 22 illustrated here intersects in a direction orthogonal to the arrangement direction. The connector 40 is attached to the distal end of the wiring intersection body 22 with the intersection direction of the wiring intersection body 22 as the insertion/removal direction with respect to the mating connector (FIG. 2). In the wiring branch body 23, the circuit branch body 33 of the circuit conductor 30 is routed for each bus bar 10 (FIG. 2). In the wiring branch body 23, a portion of the circuit branch body 33 exposed from the insulating coating is indirectly connected to the bus bar 10 or directly connected to the bus bar 10 via a terminal fitting (not illustrated).

As described above, in the wiring component 20 of the present embodiment, the wiring main body 21, the wiring intersection body 22, and the plurality of wiring branch bodies 23 are arranged on the same plane. In the wiring component 20, the wiring intersection body 22 to which the connector 40 is attached at the distal end is made to intersect in the arrangement direction (here, in an orthogonal manner) to protrude from the one side end 21b of the wiring main body 21, and all the wiring branch bodies 23 for the respective bus bars 10 are branched from the one side end 21b of the wiring main body 21. Therefore, in the wiring component 20, when the number of circuits (that is, the circuit conductor 30) is increased, the wiring main body 21 is enlarged in the direction (that is, in the width direction between the one side end 21b and the other side end 21c) orthogonal to the arrangement direction, and the wiring intersection body 22 is enlarged in the direction orthogonal to the intersection direction. When the number of circuits is increased, in the wiring component 20 of the present embodiment, the wiring main body 21 can be enlarged in the width direction such that the one side end 21b is separated from the other side end 21c, and the wiring intersection body 22 can be enlarged toward the side where the wiring branch body 23 is present, so that it is possible to prevent the enlargement of the entire body or to suppress the enlargement ratio of the entire body.

In the conductive module 1, conductor patterns (circuit conductors 30) of a plurality of wiring components 20 are formed on a laminate of various films (base film and cover film) larger than the wiring components 20, the laminate is cut for each wiring component 20, and a plurality of wiring components 20 are cut out from the laminate. In the wiring component 20 of the present embodiment, even when the number of circuits is increased, it is possible to prevent the enlargement of the entire body or suppress the enlargement ratio of the entire body to be low, and thus, it is possible to suppress a decrease in the yield rate when cutting out from the laminate.

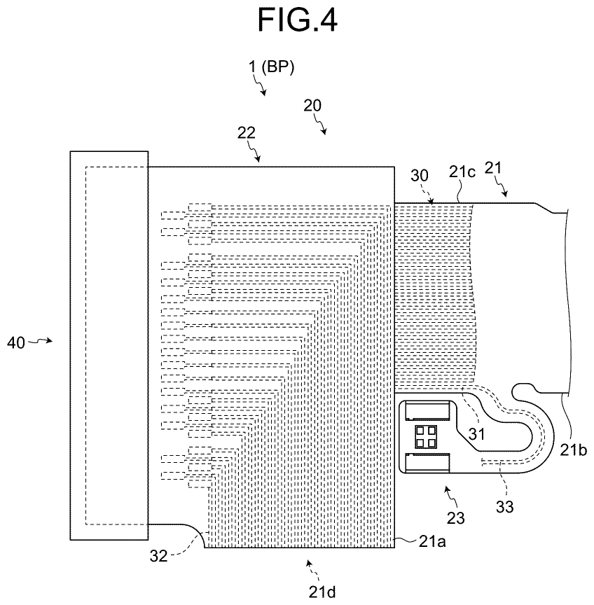

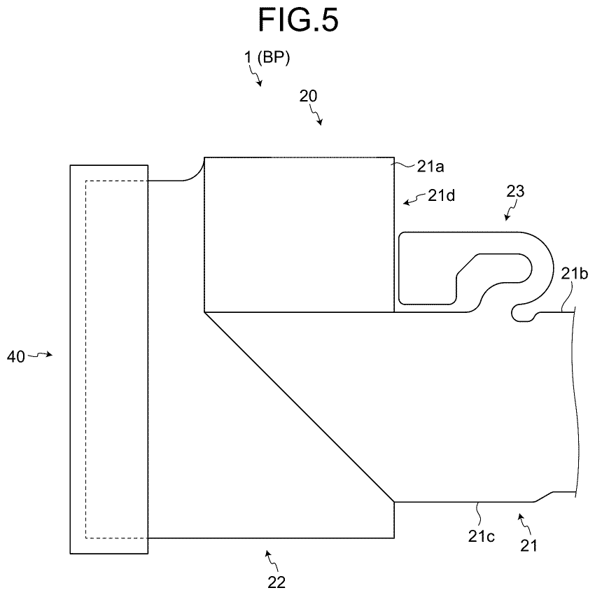

Here, the wiring component 20 is provided with a bent region 21d at one end 21a of the wiring main body 21, and the bent region 21d is bent to change an insertion/removal direction of the connector 40 with respect to the mating connector (FIGS. 1, 2, 4, and 5). For example, the connector 40 can change the insertion/removal direction from the intersection direction of the wiring intersection body 22 to the arrangement direction by bending the bent region 21d twice (FIGS. 4 and 5). In the connector 40 illustrated here, the bent region 21d is bent twice and arranged on an extension line of the wiring main body 21 in the arrangement direction, and the insertion/removal direction is changed from the intersection direction to the arrangement direction.

As described above, since the conductive module 1 of the present embodiment can easily cope with the change in the insertion/removal direction of the connector 40, the connector 40 can be provided at an appropriate position according to the arrangement of the mating connector. Furthermore, since the conductive module 1 of the present embodiment can suppress a decrease in the yield rate of the wiring component 20 when the number of circuits is increased, an increase in cost can be suppressed to be low, and cost can be reduced.

### Modification

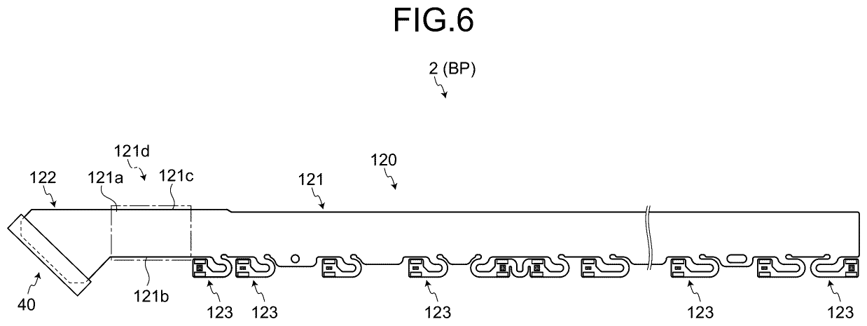

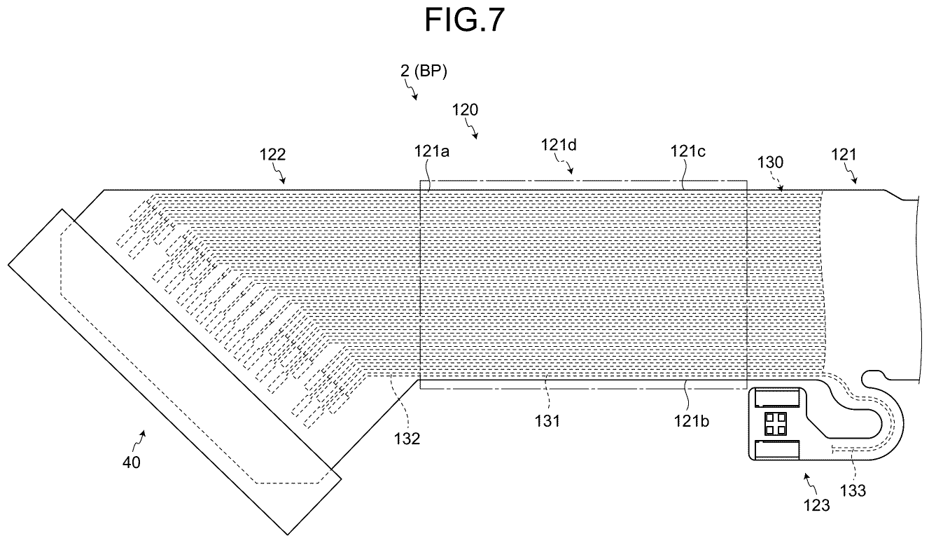

A conductive module 2 of the present modification is obtained by replacing the wiring component 20 with the following wiring component 120 in the conductive module 1 of the above-described embodiment (FIGS. 6 and 7). Similarly to the wiring component 20 of the embodiment, the wiring component 120 of the present modification is formed to be flexible and flat by including a circuit conductor 130 for each bus bar 10. The wiring component 120 includes a wiring main body 121, a wiring intersection body 122, and a plurality of wiring branch bodies 123 on the same plane, which are similar to those of the wiring component 20 of the embodiment (FIGS. 6 and 7). The circuit conductor 130 includes a circuit main body 131, a circuit intersection body 132, and a circuit branch body 133 similar to those of the circuit conductor 30 of the embodiment (FIG. 7).

Similarly to the wiring main body 21 of the embodiment, the wiring main body 121 runs in parallel in the arrangement direction and extends the circuit main body 131 in the arrangement direction (FIGS. 6 and 7). Then, in the wiring main body 121, between one side end 121b and the other side end 121c, the circuit main bodies 131 of all the circuit conductors 130 for each of the bus bars 10 are caused to run in parallel along the arrangement direction at intervals from each other (FIGS. 6 and 7).

Similarly to the wiring intersection body 22 of the embodiment, the wiring intersection body 122 is connected to one end 121a of the wiring main body 21 in the arrangement direction on the same plane so as to intersect the arrangement direction, and protrudes from one side end 121b of the wiring main body 121 (FIGS. 6 and 7). Similarly to the circuit intersection body 32 of the embodiment, the circuit intersection body 132 is connected to one end of the circuit main body 131 at one end 121a of the wiring main body 121, extends in the intersection direction of the wiring intersection body 122 in the middle of the routing path, and is electrically connected to the battery monitoring unit via the connector 40 attached to the distal end of the wiring intersection body 122 before being extended (FIGS. 6 and 7). In the wiring intersection body 122, all the circuit intersection bodies 132 for the respective bus bars 10 run in parallel along the intersection direction at intervals. The connector 40 is attached to the distal end of the wiring intersection body 122 with the intersection direction of the wiring intersection body 122 as the insertion/removal direction (FIGS. 6 and 7). However, the wiring intersection body 122 of the present modification intersects with the direction inclined with respect to the arrangement direction (FIGS. 6 and 7).

Similarly to the wiring branch body 23 of the embodiment, the wiring branch body 123 is branched from the one side end 121b of the wiring main body 121 (FIGS. 6 and 7). Similarly to the circuit branch body 33 of the embodiment, the circuit branch body 133 is led from the other end of the circuit main body 131 to the wiring branch body 123 and is electrically connected to the bus bar 10 (FIG. 7). In the wiring branch body 123, the circuit branch body 133 is routed for each bus bar 10 (FIG. 7). In the wiring branch body 123, a portion of the circuit branch body 133 exposed from the insulating coating is indirectly connected to the bus bar 10 or directly connected to the bus bar 10 via a terminal fitting (not illustrated).

As described above, similarly to the wiring component 20 of the embodiment, in the wiring component 120 of the present modification, the wiring main body 121, the wiring intersection body 122, and the plurality of wiring branch bodies 123 are arranged on the same plane. In the wiring component 120, similarly to the wiring component 20 of the embodiment, the wiring intersection body 122 to which the connector 40 is attached at the distal end is made to intersect in the arrangement direction (here, in an inclined manner with respect to the arrangement direction) to protrude from the one side end 121b of the wiring main body 121, and all the wiring branch bodies 123 for each bus bar 10 are branched from the one side end 121b of the wiring main body 121. Therefore, in the wiring component 120, similarly to the wiring component 20 of the embodiment, when the number of circuits (that is, the circuit conductor 130) is enlarged, the wiring main body 121 is enlarged in the direction (that is, in the width direction between the one side end 121b and the other side end 121c) orthogonal to the arrangement direction, and the wiring intersection body 122 is increased in the direction orthogonal to the intersection direction. When the number of circuits is increased, in the wiring component 120 of the present modification, similarly to the wiring component 20 of the embodiment, the wiring main body 121 can be enlarged in the width direction such that the one side end 121b is separated from the other side end 121c, and the wiring intersection body 122 can be enlarged toward the side where the wiring branch body 123 is present, so that the enlargement ratio of the entire body can be suppressed to be low. Therefore, similarly to the wiring component 120 of the embodiment, the wiring component 20 of the present modification can suppress a decrease in the yield rate when cutting out from the laminate even when the number of circuits is increased.

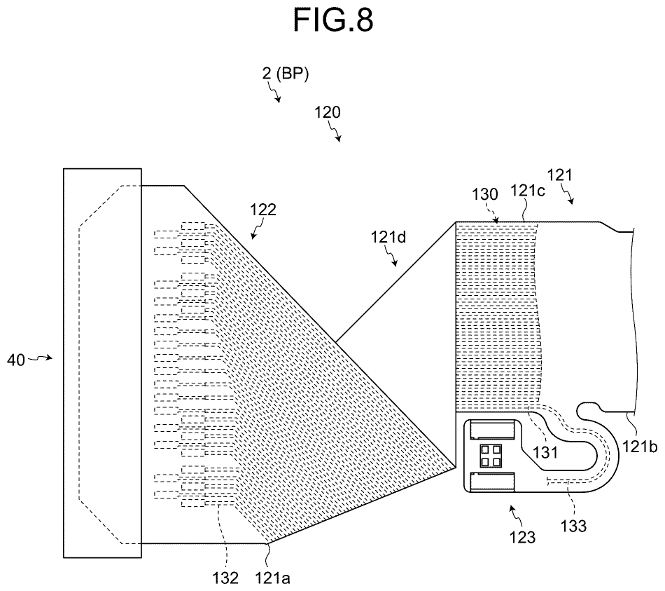

In the wiring component 120 of the present modification, similarly to the wiring component 20 of the embodiment, a bent region 121d is provided at one end 121a of the wiring main body 121, and the bent region 121d is bent to change the insertion/removal direction of the connector 40 with respect to the mating connector (FIGS. 6 to 8). For example, as in the embodiment, the connector 40 can change the insertion/removal direction from the intersection direction of the wiring intersection body 122 to the arrangement direction by bending the bent region 121d twice (FIG. 8). In the connector 40 illustrated here, the bent region 121d is bent twice and arranged on an extension line of the wiring main body 121 in the arrangement direction, and the insertion/removal direction is changed from the intersection direction to the arrangement direction.

As described above, similarly to the conductive module 1 of the embodiment, since the conductive module 2 of the present modification can easily cope with the change in the insertion/removal direction of the connector 40, the connector 40 can be provided at an appropriate position according to the arrangement of the mating connector. Furthermore, similarly to the conductive module 1 of the embodiment, the conductive module 2 of the present modification can suppress a decrease in the yield rate of the wiring component 120 when the number of circuits is increased, so that an increase in cost can be suppressed to a low level or a cost can be reduced.

Since the conductive module according to the present embodiment can easily cope with change in an insertion/removal direction of a connector, the connector can be provided at an appropriate position according to arrangement of a mating connector.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a wiring component and a connector that electrically connect a battery module in which a plurality of battery cells are arranged and a battery monitoring unit that monitors a battery state of the battery cell, wherein
the wiring component includes a circuit conductor for each bus bar connected to an electrode terminal of one or a pair of the battery cells of the battery module, is formed to be flexible and flat, and includes a wiring main body that runs parallel in an arrangement direction of the plurality of battery cells, a wiring intersection body that is connected to one end of the wiring main body in the arrangement direction so as to intersect the arrangement direction on the same plane and protrudes from one side end of the wiring main body along the arrangement direction, and a wiring branch body that is branched from the one side end of the wiring main body for each of the plurality of bus bars,
the circuit conductor includes a circuit main body extended in the arrangement direction by the wiring main body, a circuit intersection body connected to one end of the circuit main body at the one end of the wiring main body, extended in an intersection direction of the wiring intersection body in the middle of a routing path, and electrically connected to the battery monitoring unit via the connector attached to a distal end of the wiring intersection body before being extended, and a circuit branch body led from other end of the circuit main body to the wiring branch body and electrically connected to the bus bar, and
the wiring component bends a bent region provided at the one end of the wiring main body to change an insertion/removal direction of the connector with respect to a mating connector.

2. The conductive module according to claim 1, wherein
the wiring intersection body intersects in a direction orthogonal to the arrangement direction, and
the connector is attached to the distal end of the wiring intersection body with the intersection direction of the wiring intersection body as the insertion/removal direction, and the insertion/removal direction is changed from the intersection direction to the arrangement direction by bending the bent region twice.

3. The conductive module according to claim 1, wherein
the wiring intersection body intersects with a direction inclined with respect to the arrangement direction, and
the connector is attached to the distal end of the wiring intersection body with the intersection direction of the wiring intersection body as the insertion/removal direction, and the insertion/removal direction is changed from the intersection direction to the arrangement direction by bending the bent region twice.

4. The conductive module according to claim 2, wherein
the connector bends the bent region twice, is arranged on an extension line of the wiring main body in the arrangement direction, and changes the insertion/removal direction from the intersection direction to the arrangement direction.

5. The conductive module according to claim 3, wherein
the connector bends the bent region twice, is arranged on an extension line of the wiring main body in the arrangement direction, and changes the insertion/removal direction from the intersection direction to the arrangement direction.
